(19) United States
(12) Patent Application Publication
(10) Pub. No.: US 2004/0013807 A1
(43) Pub. Date: Jan. 22, 2004

(54) Treating fabric for manufacturing filter bags

(76) Inventors: Don Chase, Wamberal (AU); Mark DeRavin, Coogee (AU); Christos Skourtis, Grovedale (AU); Niall Finn, Lethbridge (AU)

Correspondence Address: MERCHANT & GOULD PC, P.O. BOX 2903, MINNEAPOLIS, MN, 55402-0903, US

(21) Appl. No.: 10/381,930

(22) PCT Filed: Oct. 5, 2001
(86) PCT No.: PCT/AU01/01255

(30) Foreign Application Priority Data
Oct. 5, 2000 (AU) PR 0575

(51) Int. Cl. B05D 3/12; B05D 3/02; B05D 1/18

(52) U.S. Cl. 427/365; 427/430.1; 427/385.5; 118/620; 118/58; 118/100; 118/200

(57) ABSTRACT

The present invention relates to a method of treating fabric suitable for manufacturing filter bags, the method including the step of: applying a coating material to the fabric configured as seamless tubing to form a coating of said coating material on an outside surface of the seamless tubing, thereby improving the filtering charateristics of the fabric.

The present invention relates to a method and apparatus for treating fabric suitable for manufacturing filter bags.

In the past, filter bags have been made from flat sheets of fabric that have been pre-treated with a coating material to improve the filtering characteristics of the fabric. Specifically, the filter bags have been manufactured previously by overlapping and sewing together opposite side edges of the pre-treated flat sheets to form a tube. Each tube has then been cut into a plurality of sections which are sewn at one end to form a bag.

It is an object of the present invention to provide an alternative method and apparatus for treating fabric suitable for manufacturing filter bags.

According to the present invention there is provided a method of treating fabric suitable for manufacturing filter bags, the method including:

applying a coating material to the fabric configured as seamless tubing to form a coating of said coating material on an outside surface of the seamless tubing, thereby improving the filtering characteristics of the fabric.

The method of the present invention avoids the need to sew a seam along the length of each filter bag.

According to the present invention there is also provided a method for manufacturing filter bags using seamless tubing made of suitable fabric for filtering, the method including the steps of:

a) applying a coating material to form a coating on an outside surface of the seamless tubing for improving the filtering characteristics of the seamless tubing.

It is preferred that the method of manufacturing filter bags also includes the steps of:

b) severing the seamless tubing into a plurality of sections; and

c) closing one end of each section to form the filter bag.

It would be understood by a person skilled in the art of the present invention that steps a) to c) may be carried out consecutively in a continuous process, disjunctively with pauses between each step or with other intervening steps. Although it is possible that steps a) to c) may be carried out in any order, it is preferred that that steps a) to c) be carried out consecutively.

It is preferred that step a) includes applying the coating material entirely over the outside surface of the seamless tubing. The coating may be an uneven or a substantially even thickness.

It is preferred that step a) includes applying the coating material by:

forming a reservoir of coating material at a coating head of a coating machine;

feeding the seamless tubing through the reservoir so that coating material is applied to the outside surface of the seamless tubing.

It is preferred that step a) includes:

curing the coating material in a curing section of the coating machine; and

pressing the seamless tubing for increasing the bonding of the coating material to the seamless tubing and/or for smoothing the outer surface of the coating material and/or otherwise altering the properties of the coating material.

Preferably, the step of curing the coating material is carried out while holding the seamless tubing taut.

Preferably, the step of pressing the seamless tubing is carried out by passing the seamless tubing through two consecutive pairs of rollers, one pair of rollers being arranged horizontally and the other pair of rollers being arranged vertically.

It is preferred that step a) includes tensioning the seamless tubing in a direction transverse to its longitudinal axis such that the outside surface is smooth to enable the coating material to be applied in a substantially even thickness.

The seamless tubing may be supplied to the coating machine as an open-end tube.

Alternatively, the seamless tubing may be supplied from a roll or coil in a flattened configuration.

Regardless of the configuration of the seamless tubing in which it is supplied, it is preferred that the method includes:

feeding the seamless tubing through the coating head over a support member located on the inside of the seamless tubing, the support member includes a portion of increasing perimeter which progressively stretches the walls of the seamless tubing outwardly to form a smooth outer surface, thereby allowing an even thickness of coating material to be applied to the seamless tubing.

If the seamless tubing is not tensioned or stretched as it passes through the coating head, the outside surface of the seamless tubing may be creased or wrinkled. Using techniques currently available, it is very difficult to apply the coating material at an even thickness over a creased or wrinkled surface of the seamless tubing. It is therefore preferred that the surface of the tubing be smoothed using the methods described above.

Preferably, the coating material is a foam polymer. Even more preferably, the coating material is an acrylic foam.

According to the present invention there is also provided an apparatus for treating fabric suitable for manufacturing filter bags, the apparatus including:

means for applying a coating material to form a coating on the fabric for improving the filtering characteristics of the fabric, wherein said fabric is in the form of seamless tubing and said coating is applied to an outside surface of the seamless tubing.

It is preferred that the apparatus includes:

means for curing the coating material; and

means for pressing the seamless tubing for increasing the bonding of the coating material to the seamless tubing and/or for smoothing the outer surface of the coating material and/or otherwise altering the properties of the coating material.

It is preferred that the apparatus includes elongated members positioned longitudinally inside the seamless tubing for holding the seamless tubing taut as it is feed through the means for curing the coating material.

It is preferred that the means for pressing the seamless tubing includes two consecutive pairs of rollers through which the seamless tubing can be fed. Even more preferably, the means for pressing the seamless tubing includes one pair of rollers being arranged horizontally and the other pair of rollers being arranged vertically.

It is preferred that the apparatus includes a coating head having a reservoir of coating material through which the seamless tubing is able to be fed, thereby applying the coating material to the outside surface of the seamless tubing.

It is preferred that the apparatus includes a support member having a portion of increasing perimeter, wherein said portion extends through:the coating head such that the seamless tubing is able to be fed over said portion which progressively stretches the walls of the seamless tubing outwardly to form a smooth outer surface, thereby allowing an even thickness of coating material to be applied to the seamless tubing.

Preferably, the support member is positioned inside the seamless tubing without direct attachment to any other component of the apparatus.

It is preferred that the apparatus includes a plurality of rollers arranged on the outside of the seamless tubing that co-operate through the walls of the seamless tubing with either a reaction surface of the support member and/or a roller mounted on the support member for supporting the support member in the required position.

Preferably, the apparatus includes pairs of rollers, one roller of each pair being an idler roller and the other roller of each pair being a driving roller, whereby in use the seamless tubing can be positioned to pass through a nip between each of the pairs of rollers and be driven by engagement of the driving rollers with the seamless tubing in the nips.

According to one preferred embodiment of the present invention, the support member includes a frusto-conical shape having an increasing diameter that progressively stretches the diameter of the seamless tubing.

According to the preferred embodiment, the reservoir of the coating head from which the coating material is discharged is an annular shape and the portion of the support member having an increasing perimeter extends through the centre of the annular reservoir such that, in use, the seamless tubing is able to be stretched as the coating material is applied to the seamless tubing.

According to an alternative embodiment of the apparatus of the present invention, the supporting member includes a plate having a width that increases transversely to the direction of movement of the seamless tubing which progressively stretches the seamless tubing.

Preferably, the coating head of the alternative embodiment is in the form of a rectangular reservoir of coating material through which extends the plate having a width greater than the width of the seamless tubing.

Even more preferably, the reservoir of the coating head of the alternative embodiment includes:

a) two chambers with openings for discharging the coating material, the two chambers being separated by a spacing A over a width B in a direction transverse to the spacing A; and

b) adjustable side members for adjusting the width B; wherein said plate extends through the spacing A.

An advantage with the alternative embodiment is that different sizes of seamless tubing can be fed through the same coating head by adjusting the width B of the reservoir to fit any plate large enough to stretch the seamless tubing as it is fed through the coating head. In contrast, the preferred embodiment of the present invention may require a different sized annular coating head to accommodate different sized diameter tubing.

Preferably, the coating head of either the preferred embodiment or the alternative embodiment includes means for varying the thickness of the coating of the coating material applied to the seamless tubing.

It is preferred that the coating head of either the preferred embodiment or the alternative embodiment includes a barrier, preferably in the form of a blade, which is positioned at a trailing edge of the reservoir of the coating head at a desired distance from the seamless tubing, thereby delimiting the maximum thickness of the coating of the coating material applied to the seamless tubing.

Two preferred embodiments of the present invention will now be described in detail with reference to the accompanying drawings, in which:

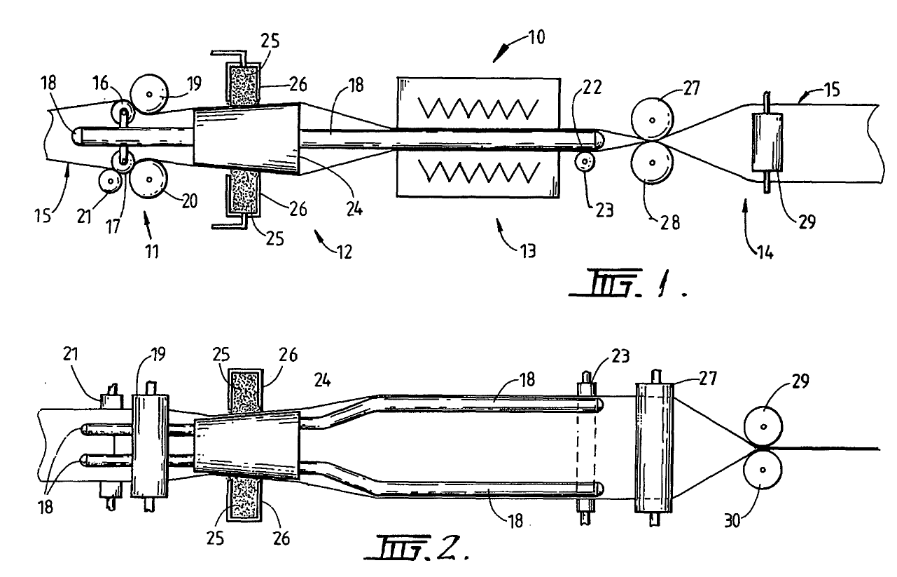

FIG. 1 is a side view of one preferred embodiment of the present invention;

FIG. 2 is a plan view of FIG. 1;

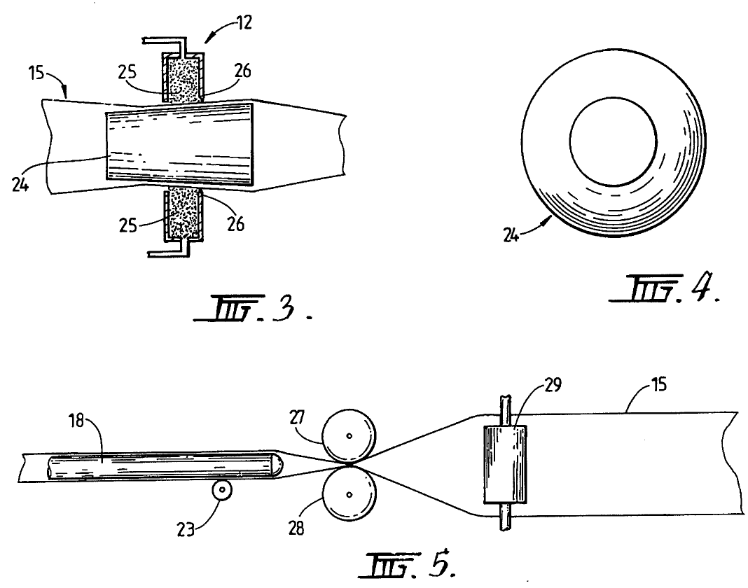

FIG. 3 is an enlarged view of a coating head of the embodiment shown in FIGS. 1 and 2;

FIG. 4 is an end view of frusto-conical member of the coating head shown in FIGS. 1, 2 and 3.

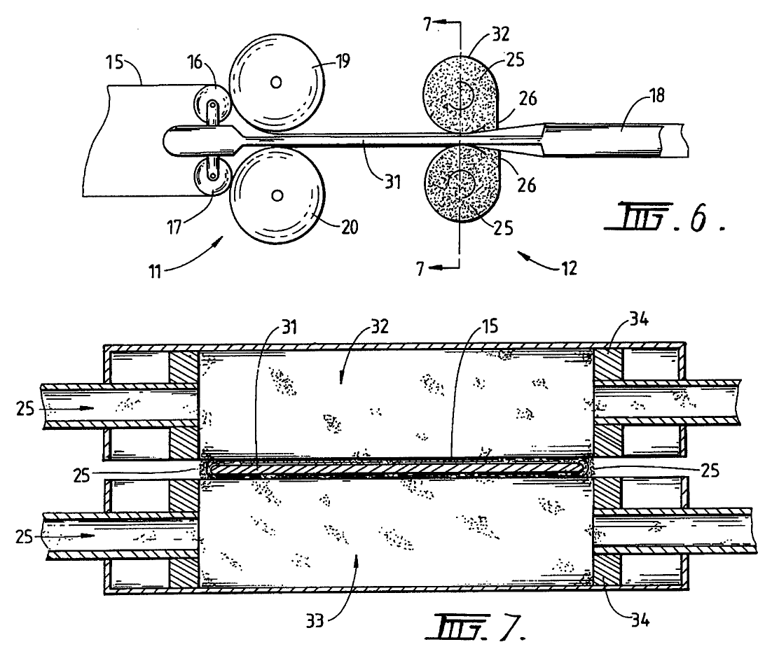

FIG. 5 is an enlarged view of a pressing section of the embodiment shown in FIGS. 1 and 2.

FIG. 6 is a side view of an alternative preferred embodiment of the present invention;

FIG. 7 is a cross-section through the line 7-7 in FIG. 7.

As can be seen in FIGS. 1 and 2, the preferred embodiment of the present invention includes a coating machine generally identified by the reference numeral 10. The coating machine 10 includes a feeding mechanism 11, a coating head section 12, a curing section 13 and a pressing section 14.

The arrows in FIG. 1 indicate the direction of movement of seamless tubing 15 through the coating machine 10. The seamless tubing is made using suitable fabric and known techniques, such as knitting the fabric in a series of layers of loops.

Although not illustrated in the figures, the seamless tubing 15 is supplied to the feeding mechanism 11 by unrolling continuous-lengths of the seamless tubing stored in a roll. An end of the seamless tubing is then threaded through the feeding mechanism 11 of the coating machine. The feeding mechanism includes upper and lower pairs of rollers at the front of the coating machine.

Specifically, the feeding mechanism 11 includes two idling rollers 16, 17 mounted to the top and bottom of a support member includes an elongated frame 18 that extends through the feeding mechanism 11, the coating head 12, and the curing section 13. The seamless tubing is threaded over the two idling rollers 16, 17 so that the elongated frame 18 is disposed on the inside of the seamless tubing 15.

The feed mechanism 11 also includes a pair of driving rollers 19, 20 having a larger diameter than the idling rollers 16, 17. The driving rollers 19,20 are located above and below the seamless tubing and engage the outside surface of the tubing for driving it forward through the machine.

The feeding mechanism 11 also includes one or more external idler rollers positioned adjacent the lower idler roller 17. As can be seen in FIG. 1, external idler roller 21 and the driving roller 20 are positioned to define a seat for one end of the frame 18. The positioning of the driving rollers and the external idler roller thereby determines the position of the elongated frame 18 relative to the coating head 12 and the curing section 13.

The elongated frame 18 extends past the curing section 13. A small idler roller 23 arranged externally of the tubing 15 co-operates through the walls of the seamless tubing 15 with a reaction surface 22 of the elongated frame 18 that is located toward the end of the frame 18 beyond the curing section 13.

Accordingly, the support member, including a mandrel of increasing perimeter and frame 18, is supported through the walls of the seamless tubing 15 by a number of external rollers that co-operate with rollers mounted on the frame 18 and a reaction surface of the frame 18.

As can best be seen in FIGS. 3 and 4, the preferred embodiment of the invention is characterised by the support member having a frusto-conical mandrel or truncated cone 24 that is mounted to the elongated frame 18. Surrounding the truncated cone 24 is the coating head 12 in the form of an annular reservoir to which the coating materials 25 is supplied.

As the seamless tubing 15 is fed through coating head 12 in the direction of the arrows shown in FIG. 1, the seamless tubing is progressively stretched over the truncated cone 24 to form a smooth outer surface. Simultaneously, the coating material 25 is discharged from the coating head onto said smooth outer surface in a continuous process. The at which the seamless tubing 15 is fed through the coating machine therefore determines the rate at which the coating material 25 is supplied to and discharge from the coating head 26.

As can best be seen in FIG. 3, a barrier, preferably in the form of a blade 26 is located at the trailing edge of the coating head 12 and assists in spreading the coating material 25 over the entire outside surface of the seamless tubing 15. The maximum thickness of the coating material 25 applied to the seamless tubing 15 is determined by the spacing between the blade 26 and the stretched surface of the seamless tubing passing through the coating head 12. Moving the coating head along the truncated cone 25 varies the spacing between the blade 26 and the seamless tubing surface stretched over the truncated cone 24, thereby enabling the thickness of the coating of the coating material 25 to be varied.

Once the seamless tubing has been stretched and the coating material 25 applied to the outer surface, the seamless tubing may relax to its normal dimensions. However, it is preferred that the seamless tubing be held taut by two parallel bars, best seen in FIG. 2, that form part of the frame 18 as the seamless tubing is fed through the curing section 13. The curing section 13 is operated at suitable conditions for curing the coating material.

Preferably, the coating material is a foam polymer which enhances the filtering characteristics of the fabric. Even more preferably, the coating material 25 is an acrylic foam and when applied to the tubing 15, the combination of the acrylic foam and the fabric have suitable properties for filtering.

As can be seen in FIG. 5, the pressing section 14 of the coating machine comprises two pairs of rollers. The first pair 27, 28 is arranged horizontally and the second pair 29, 30 is arranged vertically. The roller 28 located beneath the seamless tubing in the first pair of rollers is a driving roller that assists in feeding the seamless tubing 15 through the coating machine, and the roller 29 located above the seamless tubing is adjustable to vary the pressing force applied to the seamless tubing as it passes through the nip of the first pair of rollers. The purpose of the pressing section is to increasing the strength of the bond between the coating material and the seamless tubing 15 and/or for smoothing the layer of coating material and/or otherwise alter the properties of the coating material.

The seamless tubing exiting the coating machine 10 in FIGS. 1, 2 and 5 is then manufactured into filter bags by the steps: a) severing the seamless tubing into a plurality of sections by cutting; and b) closing one end of each section by sewing or bonding across the width of each section to form a filter bag.

Steps a) and b) are not illustrated in detail in the Figures but can be carried out using any suitable equipment and techniques.

FIGS. 6 and 7 illustrate an alternative preferred embodiment of the present invention. The coating machine of the alternative preferred embodiment includes a number of similar components to those of the preferred embodiment. Accordingly, for clarity and consistency, the same reference numerals will be used to identify components similar to those of the preferred embodiment. Furthermore, steps a) and b) mentioned in the previous paragraph apply equally when using the alternative preferred embodiment.

According to the alternative preferred embodiment of the present invention, the support member includes a plate 31 having a width that increases transversely to the direction of movement of the seamless tubing 15 through the machine 10. The seamless tubing is therefore progressively stretched around the plate 31 as it passes through the coating head 12.

FIG. 7 illustrates the reservoir of the coating head including two chambers 32, 33. Chamber 32 is located above the seamless tubing 15 and the other chamber 33 is located beneath at a sufficiently spacing to allow the plate 31 and seamless tubing to extend therebetween. Each chamber 32, 33 has openings for discharged the coating material 25 onto the seamless tubing. Adjustable sides, preferably in the form of plunging members 34, can be moved inwardly or outwardly to adjust the width of the spacing between the chambers 32,33 so that different sized tubing can be coated using an appropriately sized plate 31 through the coating head.

FIG. 7 illustrates that the width of spacing between the two chambers is set sufficiently large to allow the coating material 25 to flow around the sides of the seamless tubing stretched around the plate. This ensures that coating material 25 is also applied to the seamless tubing at the edges of the plate 25.

The coating machine of the alternative preferred embodiment of the invention is arguably a more versatile because it can be readily adjusted for coating a greater range of sizes of tubing. However, the preferred embodiment may achieve a more consistent application of the coating material over the entire outside surface of the seamless tubing on account that the coating material is applied from an annular reservoir extending around the tubing.

The curing 13 and pressing 14 sections of the alternative preferred embodiment are identical to those of the preferred embodiment.

It will be understood by persons skilled in the art of the present invention that many modifications may be made without departing from the spirit and scope of the invention described above.

For example, the coating material may be sprayed on the seamless tubing as it passes through the coating head, thus avoiding the need for a coating head reservoir.

The claims defining the invention are as follows:

1. A method of treating fabric suitable for manufacturing filter bags, the method including the step of:
applying a coating material to the fabric configured as seamless tubing to form a coating of said coating material on an outside surface of the seamless tubing, thereby improving the filtering characteristics of the fabric.

2. The method according to claim 1 wherein the step of applying the coating material is carried out by:
forming a reservoir of the coating material; and
feeding the seamless tubing through the reservoir so that the coating material is applied to the outside surface of the seamless tubing.

3. The method according to claim 1 or 2 including the steps of:
curing the coating material using hot air; and
pressing the seamless tubing to increase the bonding of the coating material to the seamless tubing and/or to smooth the outer surface of the coating material and/or otherwise alter the properties of the coating material.

4. The method according to claim 3 wherein the step of curing the coating material is carried out while holding the seamless tubing taut.

5. The method according to claim 3 or 4 wherein the step of pressing the seamless tubing is carried out by passing the seamless tubing between a pair of rollers.

6. The method according to claim 3 or 4 wherein the step of pressing the seamless tubing is carried out by passing the seamless tubing through two consecutive pairs of rollers, one pair of rollers being arranged horizontally and the other pair of rollers being arranged vertically.

7. The method according to any one of the preceding claims wherein the step of applying the coating material includes tensioning the seamless tubing in a direction transverse to its longitudinal axis such that the outside surface is smooth to enable the coating material to be applied in a substantially even thickness.

8. The method according to any one of the preceding claims wherein the coating material is applied over the entire outer surface of the seamless tubing.

9. The method according to any one of the preceding claims wherein the step of applying the counting material includes:
feeding the seamless tubing over a support member located on the inside of the seamless tubing, the support member includes a portion of increasing perimeter which progressively stretches the walls of the seamless tubing outwardly to form a smooth outer surface, thereby allowing an even thickness of coating material to be applied to the seamless tubing.

10. The method according to any one of the preceding claims wherein the coating material is a foam polymer.

11. The method according to any one of the preceding claims wherein the coating material is an acrylic foam.

12. A method of manufacturing filter bags using seamless fabric tubing, the method including the step of:
a) applying a coating material to form a coating on an outside surface of the seamless tubing so as to improve the filtering characteristics of the seamless tubing.

13. The method according to claim 12 including the steps of:
b) severing the seamless tubing into a plurality of sections; and
c) closing one end of each section to form the filter bag.

14. The method according to claim 12 or 13 wherein step a) includes:
forming a reservoir of the coating material; and
feeding the seamless tubing through the reservoir so that the coating material is applied to the outside surface of the seamless tubing.

15. The method according to any one of claims 12 to 14 wherein step a) includes:
curing the coating material using hot air; and
pressing the seamless tubing to increase the bonding of the coating material to the seamless tubing and/or to smooth the outer surface-of the coating material and/or otherwise alter the properties of the coating material.

16. The method according to claim 15 wherein the step of curing the coating material is carried out while holding the seamless tubing taut.

17. The method according to claim 15 wherein the step of pressing the seamless tubing is carried out by passing the seamless tubing between a pair of rollers.

18. The method according to claim 15 wherein the step of pressing the seamless tubing is carried out by passing the seamless tubing through two consecutive pairs of rollers, one pair of rollers being arranged horizontally and the other pair of rollers being arranged vertically.

19. The method according to any one of claims 12 to 18 wherein step a) includes:
tensioning the seamless tubing in a direction transverse to its longitudinal axis such that the outside surface is smooth to enable the coating material to be applied in a substantially even thickness.

20. The method according to any one of claims 12 to 19 wherein step a) includes:
feeding the seamless tubing over a support member located on the inside of the seamless tubing, the support member includes a portion of increasing perimeter which progressively stretches the walls of the seamless tubing outwardly to form a smooth outer surface, thereby allowing an even thickness of coating material to be applied to the seamless tubing.

21. The method according to any one of claims 12 to 20 wherein the coating material is applied over the entire outer surface of the seamless tubing.

22. The method according to any one of claims 12 to 21 wherein the coating material is a foam polymer.

23. The method according to any one of claims 12 to 22 wherein the coating material is an acrylic foam.

24. An apparatus for treating fabric suitable for manufacturing filter bags, the apparatus including:
means for applying a coating material to form a coating on the fabric for improving the filtering characteristics of the fabric, wherein said fabric is in the form of seamless tubing and said coating is applied to an outer surface of the seamless tubing.

25. The apparatus according to claim 24 including:
means for curing the coating material; and
means for pressing the seamless tubing for increasing the bonding of the coating material to the seamless tubing and/or for smoothing the outer surface of the coating material and/or for altering the properties of the coating material.

26. The apparatus according to claim 25 including elongated members positioned longitudinally inside the seamless tubing for holding the seamless tubing taut as it is fed through the means for curing the coating material.

27. The apparatus according to claim 25 or 26 wherein the means for pressing the seamless tubing includes two consecutive pairs of rollers through which the seamless tubing can be fed.

28. The apparatus according to any one of claims 25 to 27 wherein the means for pressing the seamless tubing includes a pair of rollers between which the seamless tubing can pass.

29. The apparatus according to any one of claims 25 to 28 wherein the means for pressing the seamless tubing includes one pair of rollers being arranged horizontally and the other pair of rollers being arranged vertically between which the seamless tubing can pass.

30. The apparatus according to any one of claims 25 to 29 including a coating head having a reservoir of coating material through which the seamless tubing is able to be fed, thereby applying the coating material to the outside surface of the seamless tubing.

31. The apparatus according to claim 30 including a support member having a portion of increasing perimeter, wherein said portion extends through the coating head such that the seamless tubing is able to be fed over said portion which progressively stretches the walls of the seamless tubing outwardly to form a smooth outer surface, thereby allowing an even thickness of coating material to be applied to the seamless tubing.

32. The apparatus according to claim 31 wherein the support member is positioned inside the seamless tubing without direct attachment to any other component of the apparatus.

33. The apparatus according to claim 31 or 32 including a plurality of rollers arranged on the outside of the seamless tubing that co-operate through the walls of the seamless tubing with either a reaction surface of the support member and/or a roller mounted on the support member for supporting the support member in the required position.

34. The apparatus according to any one of claims 30 to 33 including one or more pairs of rollers, one roller of each pair being an idler roller and the other roller of each pair being a driving roller, whereby in use the seamless tubing can be positioned to pass through a nip between each of the pairs of rollers and be driven by engagement of the driving rollers with the seamless tubing in the nips.

35. The apparatus according to any one of claims 30 to 34 wherein the support member includes a frusto-conical shape having an increasing diameter that progressively stretches the diameter of the seamless tubing.

36. The apparatus according to claim 35 wherein the reservoir of the coating head from which the coating material is discharged is anannular shape and the portion of the support member having an increasing perimeter extends through the centre of the annular reservoir such that, in use, the seamless tubing is able to be stretched as the coating material is applied to the seamless tubing.

37. The apparatus according to any one of claims 30 to 34 wherein the supporting member includes a plate having a width that increases transversely to the direction of movement of the seamless tubing which progressively stretches the seamless tubing.

38. The apparatus according to claim 37 wherein the reservoir of the coating head is in the form of a rectangular reservoir of coating material through which extends said plate.

39. The apparatus according to claim 37 or 38 wherein the reservoir of th coating head includes:
a) two chambers with openings for discharging the coating material, the two chambers being separated by a spacing A over a width B in a direction transverse to the spacing A; and
b) adjustable side members for adjusting the width B; wherein said plate extends through the spacing A.

40. The apparatus according to any one of claims 24 to 39 including means for varying the thickness of the coating material applied to the seamless tubing.

41. The apparatus according to claim 40 including a barrier which is positioned at a trailing edge of the reservoir of the coating head at a desired distance from the outer surface of seamless tubing, thereby delimiting the maximum thickness of the coating of the coating material applied to the seamless tubing.
